(19) United States
(12) Patent Application Publication
(10) Pub. No.: US 2015/0361793 A1
(43) Pub. Date: Dec. 17, 2015

(54) METHOD FOR PRODUCING A TUBBING WITH A THERMOPLASTIC SEALING LAYER

(71) Applicant: SIKA TECHNOLOGY AG, Baar (CH)

(72) Inventors: Josef VON ROTZ, Kerns (CH); Christoph FAH, Zurich (CH)

(73) Assignee: SIKA TECHNOLOGY AG, Barr, OT (CH)

(21) Appl. No.: 14/761,797

(22) PCT Filed: Jan. 20, 2014
(86) PCT No.: PCT/EP2014/051058

§ 371 Date: Jul. 17, 2015

(30) Foreign Application Priority Data
Jan. 18, 2013 (EP) 13151974.6
Mar. 13, 2013 (CH) 00607/13

(51) Int. Cl. E21D 11/00; B32B 37/12; B32B 13/12; B32B 27/06; B32B 1/00; E21D 11/38; B29C 65/48; B29C 65/00; B32B 37/06; B32B 37/18; B32B 7/12; B32B 37/08; B29C 65/02

(52) U.S. Cl. CPC E21D 11/003; B32B 37/08; B32B 37/1207; B32B 13/12; B32B 27/06; B32B 1/00; B29C 65/022; B29C 65/4815; B29C 66/7463; B32B 37/06; B32B 37/182; B32B 7/12; E21D 11/383; E21D 11/385; B29L 2031/10

(57) ABSTRACT

The core of the invention is a method for producing a tubbing of concrete for jacketing a tunnel, in particular a traffic tunnel, wherein the tubbing has a convexly curved outer surface and a concavely curved inner surface opposite the outer surface, comprising the steps a) placing a membrane comprising a hot-melt adhesive layer and a thermoplastic sealing layer on the outer surface and, furthermore, on all sides of the outer side surfaces of the tubbing, which sides face the outer surface, wherein the hot-melt adhesive layer faces the tubbing; b) supplying heat under the partial melting of the hot-melt adhesive layer; and c) cooling the hot-melt adhesive layer with formation of an adhesive composite between membrane and the tubbing.

### TECHNICAL AREA

The present invention relates to a method for producing a tubbing of concrete for jacketing a tunnel, in particular a traffic tunnel

### PRIOR ART

Although it can be used in any construction areas, the present invention and the problems forming its basis are described in detail in the following with reference to a traffic tunnel

Steel-reinforced, finished concrete parts for the inner shell are frequently used in machine tunnel construction using the shield advance technology. These finished concrete parts, designated in professional jargon as tubbing, are prefabricated in factories for finished concrete parts, temporarily stored until the required strength of the concrete has been achieved and then brought as needed into the tunnel tube for installation. There they are taken up in the protection of the shield of the tunnel boring machine by a tubbing moving apparatus, the so-called “erector” and assembled into a tubbing ring. After the tunnel boring machine was advanced under support against the last installed tubbings by hydraulic pressing, a new tubbing ring is installed in the protection of the shield. In this manner the machine works its way through the soil “tubbing ring by tubbing ring”, wherein the annular gap remaining between the tunnel extension (tubbing ring) and the ground is continuously filled with mortar in order to prevent, e.g. settling.

Not only classic traffic tunnels but, given the presence of special geological conditions, even so-called supply tunnels or disposal tunnels for households, trade or industry that serve in particular in the form of large-diameter collection lines for the central transport of wastewater or fresh water or as cable tunnels for receiving high-voltage lines are manufactured according to the previously described segmented construction method in the tubbing extension procedure. However, in all these areas of use, whether for maintaining an unobjectionable hygienic quality of drinking water or in order to avoid functional disturbances by ground moisture penetrating onto the electrical lines, elevated requirements are placed on the tightness and permanence of the tubbing jacketing of the tunnel.

For this reason a separate second work step was usually necessary for final sealing of the concavely curved outer surfaces of the tubbings facing the outside of the tunnel and/or the production of an additional, second tubbing ring.

On account of their size, tubbing rings have a high space requirement during the individual method steps in the manufacturing process, in particular if they require intermediate storage. Shortening of the manufacturing process, in particular of storage times, is therefore of great importance.

### PRESENTATION OF THE INVENTION

Therefore, the present invention has the problem of improving the manufacture of tubbings in such a manner that they are protected and sealed against moisture present on the outside of the tubbing ring and at the same time ensure an easy manufacturing process, in particular with short intermediate storage times.

This is achieved in accordance with the invention by the features of the first claim.

The core of the invention is a method for the production of a tubbing of concrete for jacketing a tunnel, in particular a traffic tunnel, wherein the tubbing 1 has a convexly curved outer surface 2 and a concavely curved inner surface 3 opposite the outer surface 2, comprising the steps
a) Placing a membrane 4 comprising a hot-melt adhesive layer 5 and a thermoplastic sealing layer 6 on the outer surface 2 and, furthermore, at least partially on at least one, in particular all of the sides of the outer side surfaces (7, 8) of the tubbing, which sides face the outer surface 2, wherein the hot-melt adhesive layer 5 faces the tubbing 1;
b) Supplying heat under the partial melting of the hot-melt adhesive layer 5;
c) Cooling off the hot-melt adhesive layer 5 under formation of an adhesive composite between membrane 4 and the tubbing 1.

The tubbing has an annular, segmented structure with a concavely curved inner surface that is directed in the installed state toward the inside of the tunnel, and with an opposing, convexly curved outer surface that is directed in the installed state toward the surrounding soil. These two surfaces are laterally connected by four other surfaces, two longitudinal side surfaces that rest in the installed state on the corresponding longitudinal side surfaces of the adjacent tubbings of the same tubbing ring and two front side surfaces that rest in the installed state on the corresponding front side surfaces of the adjacent tubbings of an adjacent tubbing ring.

As a result of the tubbings manufactured in the method according to the invention no separate second work step is required for the concluding sealing of the concavely curved outer surfaces of the tubbings facing the outside of the tunnel Also, a possible second tubbing ring is eliminated. Furthermore, tubbings with lower wall thicknesses can be used/manufactured since they are far superior to traditional tubbings as regards water tightness and resistance to corrosive ground water. Both result in reduction of the space requirement of the tunnel wall and therefore to a gain of inner space and reduction of the construction material needed. Furthermore, the tubbings produced in accordance with the invention permit the use of alternative, less water-tight and less corrosion-resistant types of concrete. Furthermore, tubbing rings made of tubbings that were manufactured in the method according to the invention have superb tightness and prevention of underflow.

It was found that high forces can be transferred between the adhered substrates after only a few minutes by using a hot-melt adhesive layer to form an adhesive bond between the membrane and the tubbing. Therefore, e.g. the gripping devices (usually vacuum gripping devices) used in finished concrete work can move the tubbing shortly after the cooling of the hot-melt adhesive layer. This rapid build-up of strength is advantageous in that no mechanical fixing means such as clamps or the like are needed for bonding. Furthermore, this makes possible an easy manufacturing process with short intermediate storage times.

Other advantageous embodiments of the invention result from the subclaims.

Other aspects of the invention constitute subject matter of other independent claims.

### BRIEF DESCRIPTION OF THE DRAWINGS

Exemplary embodiments of the invention are explained in detail in the following using the drawings.

FIG. 1 shows a side view through a tubbing.

FIG. 2 shows another side view through a tubbing.

FIGS. 3 and 4 show the steps a) and b) of the method.

Only the elements essential for the direct understanding of the invention are shown.

### WAY OF CARRYING OUT THE INVENTION

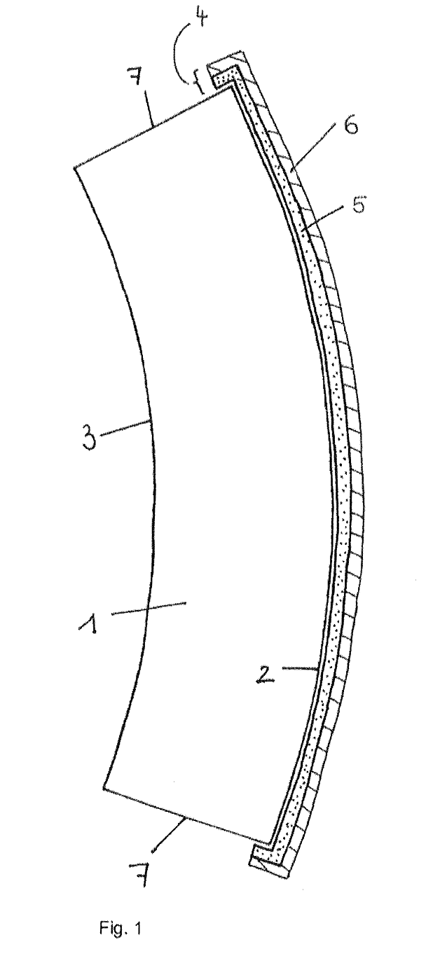

FIG. 1 shows a side view through a tubbing manufactured in accordance with the invention.

The tubbing 1 is provided on its convexly curved outer surface 2 with a membrane 4.

The membrane comprises a hot-melt adhesive layer 5 and a thermoplastic sealing layer 6, wherein the hot-melt adhesive layer 5 faces the tubbing 1.

Furthermore, the membrane is arranged over a partial area preferably on at least one, particularly preferably on all sides of the outer side surfaces (longitudinal side surfaces 7 and front side surfaces 8) that face the outer surface. FIG. 1 shows the two longitudinal side surfaces 7. Although it is not preferred, the membrane can also extend over the entire outer side surfaces 7 and 8. This ensures, among other things, excellent bonding of the hot-melt adhesive layer and therefore of the membrane with the tubbing and also ensures a high degree of protection against underflow. Furthermore, a higher sealing effect is achieved at junction positions between two tubbings by the enlargement of the contact surface of membranes contacting each other in comparison, e.g., to a membrane that lacks an arrangement on all sides of the outer side surfaces that face the outer surface.

The hot-melt adhesive layer is preferably connected over its entire surface to the outer surface 2, especially bonded, which results in improvement of the protection against underflow.

In order to be as suitable as possible as a thermoplastic sealing layer 6, it should be as watertight as possible and not decompose or be mechanically damaged even when exposed for a long time to water or moisture. In particular, those materials are suitable as thermoplastic sealing layer that are already used for sealing purposes in the prior art for above-ground and below-ground construction.

It is advantageous if the thermoplastic sealing layer is manufactured from a material with a softening point above 110° C., preferably between 140° C. and 170° C. The thermoplastic sealing layer should advantageously have at least a low amount of elasticity in order to be able to bridge stresses caused, for example, by differences of expansion between the thermoplastic sealing layer and the tubbing caused by temperatures without the thermoplastic sealing layer being damaged or tearing or the sealing function of the sealing layer being adversely affected.

The thermoplastic sealing layer preferably contains thermoplastic polyolefins and/or polyvinyl chloride (PVC).

The term “thermoplastic polyolefins” in particular does not denote natural and synthetic rubbers (according to the definition given under “rubbers” in Römpp online, version 4.0, Thieme Verlag).

The thermoplastic sealing layer especially preferably comprises material selected from the group consisting of high-density polyethylene (HDPE), medium-density polyethylene (MDPE), low-density polyethylene (LDPE), polyethylene (PE), polypropylene (PP), polyethylene terephthalate (PET), polystyrene (PS), polyvinyl chloride (PVC), polyamides (PA), ethylene vinyl acetate (EVA), chlorosulfonated polyethylene and thermoplastic polyolefins (TPO).

The thermoplastic sealing layer preferably consists of more than 50 wt %, especially preferably of more than 80 wt % of the previously cited materials.

The thermoplastic sealing layer advantageously has a layer thickness in the millimeter range, typically between 0.2 and 15 mm, preferably between 0.5 and 4 mm, most preferably between 1 and 2 mm.

The thermoplastic sealing layer preferably consists of flexible, i.e., bendable, flat sheets. Thermoplastic sealing layers are manufactured, for example, by calendering or extrusion.

The thermoplastic sealing layer is preferably not a fibrous material, in particular not a woven fabric, a bonded fabric or a fleece. However, it can be advantageous if a fibrous material, in particular a woven fabric, a bonded fabric or a fleece is worked into the thermoplastic sealing layer. The term fibrous material throughout the present document denotes a material built up from fibers.

A membrane 4 is typically produced in that in order to form the hot-melt adhesive layer 5 the hot-melt adhesive composition is heated above the melting temperature so that the hot-melt adhesive composition liquefies and is applied at the application temperature onto the thermoplastic sealing layer 6.

The application temperature is typically selected so that the viscosity of the molten hot-melt adhesive composition provides for good application with application devices customarily used with hot-melt adhesives. Therefore, the application temperature is selected in such a manner that the viscosity is preferably between 1,500-40,000 mPas measured according to Brookfield Thermosel.

The application typically takes place at the above-described application temperature preferably by doctor blade, spraying, spreading, stamping, rolling, casting, brushing, rolling, immersion or extruding on.

A hot-melt adhesive layer 5 is preferably obtained that is tack-free at 25° C.

A membrane is preferably obtained that can be cut to length, cut off, rolled up or directly further processed.

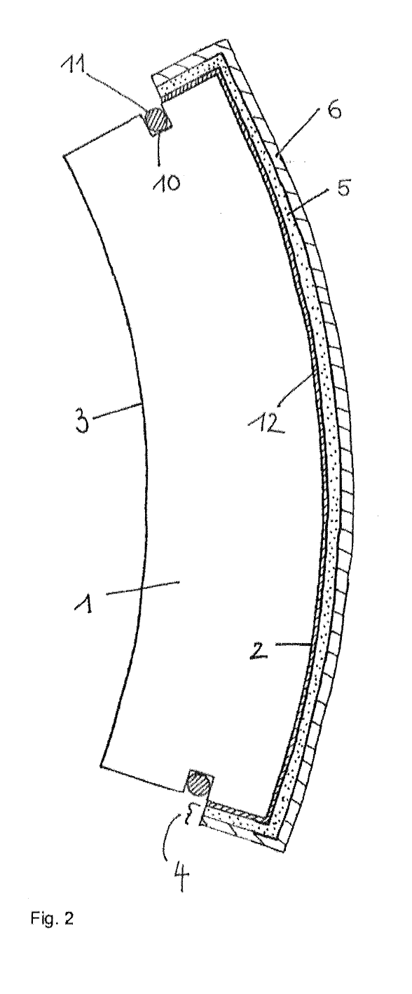

The tubbing preferably has a sealing groove 10 running around the outer side surfaces (7, 8) in which a sealing body 11 is arranged, as FIG. 2 shows. The sealing groove is molded into the tubbing and a sealing body is present in it, typically pressed into it. The sealing body 11 is typically a hollow body. In particular, suitable materials as material for the sealing body are those that are known as sealing materials for sealing rings and/or materials that can swell in water. The term “materials that can swell in water” denotes in the present document materials that increase their volume by a multiple, typically between 200-1000% of the original volume upon contact with water. In addition to the increase of volume, certain water-swellable materials also chemically react with water. Examples of such water-swellable materials are swelling substances based on polyurethane, in particular silane-modified polymers that cure by moisture to an elastic product. Another example for such swelling substances are bentonite-butyl rubbers or polymers based on acrylic acid subsumed under the name “super absorbers” (super-absorbent polymers, SAP), typically copolymers consisting of acrylic acid and sodium acrylate, for example from BASF SE, Germany.

The sealing body 11 consists especially preferably of ethylene-propylene-diene rubber (EPDM).

This has the advantage that another barrier against penetrating water is established at the joining sites between two tubbings and therefore a greater sealing action is achieved.

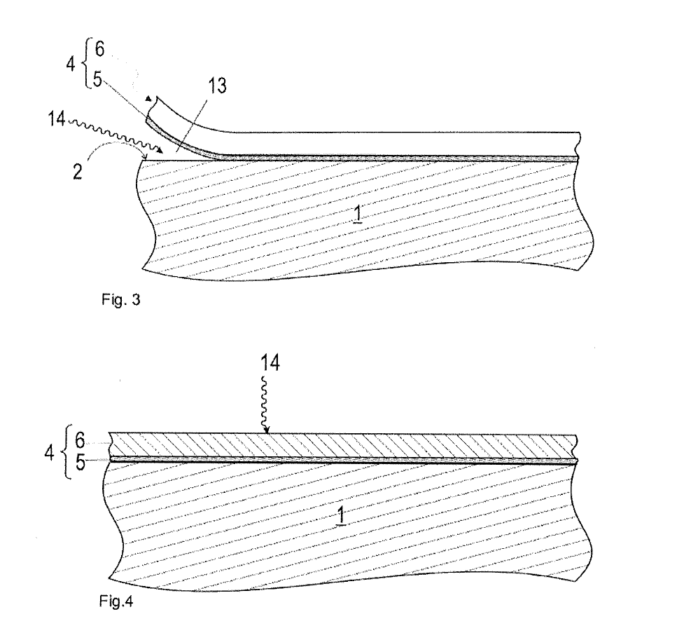

The tubbing preferably comprises a sealing coating 12 between the outer surface 2 and the hot-melt adhesive layer 5, as is apparent in FIG. 2 and FIG. 3. The sealing layer is selected from the group consisting of methacrylic resin, polyester resin, epoxy resin, polyurethane and polyurea. Epoxy resin is especially preferred as a sealing coating.

Such a sealing coating 12 is advantageous in that as a consequence the tubbing is protected from the penetration of moisture. Furthermore, this reinforces the sealing action of the tubbing. Furthermore, a severe loss of moisture during the curing of the green body can be prevented during the production of the tubbing. Sealing coating 12 is typically applied by spraying or coating it on to the tubbing.

Furthermore, it is advantageous that the sealing coating 12 is arranged at least partially on all outer side surfaces 7, 8, especially on the area between the outer surface 2 and the sealing groove 10.

All materials can be considered as sealing body 11 that are suitable to reduce or prevent the passage of liquids, especially of water.

The sealing body preferably consists of a thermoplastic or a thermoplastic elastomer. Thermoplastic elastomers have the advantage that the sealing body has as a result good elasticity relative to horizontal and vertical displacements, especially displacements due to mechanical stresses in the structure. Good elasticity of the sealing body prevents tearing or separation of the sealing body and therefore failure of the seal.

In this document thermoplastic elastomers are understood to be plastics that combine the mechanical properties of vulcanized elastomers with the workability of thermoplastics. Typically, such thermoplastic elastomers are block copolymers with hard and soft segments or so-called polymer alloys with appropriately thermoplastic and elastomeric constituents.

Other advantageous materials for sealing bodies are materials that are selected from the group consisting of acrylate compounds, polyurethane polymers, silane-terminated polymers and polyolefins.

The term “hot-melt adhesive composition” denotes in this document a composition that is solid at 25° C., melts when heated to the melting point and therefore become flowable. Such a hot-melt adhesive composition is capable of being applied onto a substrate at an application temperature above the melting point of the hot-melt adhesive composition and becoming solid again during the cooling down and as a consequence developing an adhesive force with the substrate. If the hot-melt adhesive composition is a non-reactive hot-melt adhesive composition, the hot-melt adhesive composition melts again when heated to the melting point, as a result of which the adhesive bond becomes loose again.

The term “room temperature” denotes in the present document a temperature of 25° C.

The term “melting point” denotes in the present document the softening point measured according to the ring & ball method according to DIN EN 1238.

The term “to partially melt” or “ partial melting” denotes in the present document the heating of the hot-melt adhesive composition to a temperature that is above the so-called crossover temperature (“T_{CROSSOVER}” and that is below the softening point measured according to the ring & ball method according to DIN EN 1238.

The crossover temperature, frequently also designated as the yield point, is the temperature at which the curves of the loss modulus and storage modulus measured by DTMA (Dynamic-Mechanical-Thermal Analysis) intersect. In the scope of this invention the following DTMA measuring parameters are used to determine the crossover temperature by DTMA measurement:

Device: Anton Paar MCR 300 SN 616966

Software US V2.3

Die: 25 mm plate (smooth surface)

Measuring gap: (sample thickness) 1 mm

Temperature gradient: 200° C.-90° C. at minus 1° C./min

Oscillation frequency: 1 Hz

Amplitude gamma: 1% (corresponds to 0.8 mrad).

The partial melting typically takes place at a temperature that is substantially, i.e., at least 20° C., in particular at least 30° C., preferably at least 40° C. below the softening point.

The hot-melt adhesive composition 5 preferably consists of a non-reactive hot-melt adhesive composition. The term “non-reactive” hot-melt adhesive composition denotes in this document a hot-melt adhesive composition containing no polymers that chemically react with each other either at room temperature or at the melting temperature and which would result in higher molecular weight species. Such non-reactive hot-melt adhesive compositions comprise in particular no polymers containing isocyanate- or alkoxysilane or epoxide or (meth)acrylate groups. A non-reactive hot-melt adhesive composition therefore does not contain epoxy resins, in particular no solid epoxy resins. A non-reactive hot-melt adhesive composition is advantageous in that it is tack-free, which allows storage of membranes 4 for a rather long time, in particular in the form of rolls.

The hot-melt adhesive layer is preferably directly connected to the thermoplastic sealing layer, in particular over its total surface. Preferably, no separating layer, typically with a layer thickness of ca. 5 μm to 50 μm is arranged between the hot-melt adhesive layer and the thermoplastic sealing layer. Such separating layers are used, for example in order to prevent the migration of low-molecular weight substances, for example when using bitumen-like adhesives.

The hot-melt adhesive layer 5 preferably consists of a hot-melt adhesive composition that comprises a thermoplastic poly-α-olefin that is solid at 25° C., preferably an atactic poly-α-olefin (APAO), in particular in an amount of more than 50 wt %, preferably more than 60 wt % relative to the amount of the non-reactive hot-melt adhesive composition.

In this document “α-olefin” denotes in its customary definition an alkene with the empirical formula CₓH₂ₓ (x corresponds to the number of carbon atoms), which has a C—C double bond on the first carbon atom (α-carbon). Examples of α-olefins are ethylene, propylene, 1-butene, 1-pentane, 1-hexane, 1-heptene and 1-octene. Therefore, for example, neither 1, 3-butadiene nor 2-butene or styrene are α-olefins in the sense of this document.

In this document “poly-α-olefins” denotes in its customary definition homopolymers consisting of α-olefins and copolymers consisting of several different α-olefins. Atactic poly-α-olefins (APAO) have an amorphous structure in comparison to other polyolefins. These atactic poly-α olefins preferably have a softening point above 90° C., in particular between 90° C. and 130° C. The molecular weight M_{n.} is in particular between 7,000 and 25,000 g/mole. Especially preferred atactic poly-α-olefins are obtainable under the trade name Vestoplast® from Degussa.

Propylene-rich, atactic poly-α-olefins as well as partially crystalline propylene-ethylene-butylene terpolymers are especially preferred.

The hot-melt adhesive composition furthermore advantageously contains hydrocarbon resins solid at 23° C. A carbohydrate resin solid at 23° C. preferably has a softening point of 100 to 140° C., in particular between 110 and 130° C. It was found to be especially advantageous if the amount of all hydrocarbon resins solid at 23° C. is maximally 20 wt %, in particular maximally 16 wt %, preferably between 10 and 16 wt % relative to the hot-melt adhesive composition.

The hot-melt adhesive composition furthermore advantageously contains soft resins. A soft resin has a softening point between −10° C. and 40° C. Due to the fact that the soft resin (WH) is very close to its melting or softening point at room temperature (23° C.), it is either already liquid or very soft at room temperature. A soft resin can be a natural resin or synthetic resin. In particular, such soft resins are medium- to high-molecular weight compounds from the classes of paraffin resins, hydrocarbon resins, polyolefins, polyesters, polyethers, polyacrylates or amino resins. Soft resin preferably has a melting point or softening point between 0° C. and 25° C., in particular 10° C. and 25° C. Soft resins are used only in small amounts. The amount of all soft resins is preferably maximally 20 wt % relative to the hot-melt adhesive composition.

The hot-melt adhesive composition furthermore contains maleic acid-grafted polyolefins. Maleic acid-grafted polyolefins are especially preferred since they are advantageous as regards adhesion. It proved to be especially advantageous that such maleic acid-grafted polyolefins are maleic acid-grafted polypropylenes, in particular with a molecular weight between 7,000 and 14,000 g/mol. It proved to be especially favorable if the amount of all maleic acid-grafted polyolefins is maximally 20 wt %, especially maximally 15 wt %, preferably less than 10 wt % relative to the hot-melt adhesive composition.

Furthermore, the non-reactive hot-melt adhesive composition can comprise other components. Suitable other components are in particular components selected from the group comprising plasticizers, adhesive promoters, UV absorption agents, UV and heat stabilizers, optical brighteners, fungicides, pigments, colorants, fillers and drying agents.

The hot-melt adhesive composition preferably has a melting point of 80 to 200° C., in particular 130 to 180° C., measured as the softening point according to the ring & ball method according to DIN EN 1238.

The hot-melt adhesive layer typically has an application weight of 50 to 1000 g/m², in particular 200 to 800 g/m², preferably 400 to 600 g/m². The layer thickness of the hot-melt adhesive layer is preferably between 50 and 500 micrometers, in particular between 50 and 100 micrometers.

The method of the invention comprises the step of
a) applying a membrane 4 comprising a hot-melt adhesive layer 5 and a thermoplastic sealing layer 6 on the outer surface 2 and furthermore on all sides of the outer surfaces 7, 8 of the tubbing which face the outer surface 2, wherein the hot-melt adhesive layer 5 faces the tubbing 1.

In a further step b) of the method heat is supplied so that the hot-melt adhesive layer 5 partially melts.

The supply of heat preferably takes place in such a manner in step b) that the temperature of the hot-melt adhesive layer 5 does not exceed a temperature that is at least 30° C., preferably at least 40° C. below the melting point, i.e., below the softening point of the hot-melt adhesive layer.

The supplying of heat in step b) can preferably take place during the placing of the membrane 4 in step a), in particular into the gap 13 formed during the placing between hot-melt adhesive layer 5 and the tubbing 1.

In another embodiment the supplying of heat on the side of membrane 4 opposite the hot-melt adhesive layer 5 takes place in step b) and is transferred via the thermoplastic sealing layer 6 to the hot-melt adhesive layer 5.

The supplying of heat can take place by hot air, flame, induction or dielectric heating. The supplying of heat preferably takes place in such a manner that that the heat does not have too great a negative thermal effect on or even destroy the hot-melt adhesive layer 5, the thermoplastic sealing layer 6 or the outer surface 2, or the sides of the outer side surfaces 7, 8 of the tubbing facing the outer surface.

As a consequence of the fact that the hot-melt adhesive composition starts to melt, the hot-melt adhesive composition becomes at least partially flowable, which ensures intimate contact with the tubbing surface.

In a step c) following step b) the hot-melt adhesive layer 5 is cooled with formation of an adhesive bond between membrane 4 and the tubbing 1. This cooling typically takes place without further auxiliary means. However, in certain instances it can be appropriate and advantageous if the tubbing should already be loaded or walked on in order to accelerate the cooling. This can take place, for example, in that in particular the membrane or the tubbing is cooled by a cooling means, for example, by a blower, in particular an air blower.

The supplying of heat with partial melting of the hot-melt adhesive layer 5 in step b) can take place in such a manner that

in one step the membrane 4 is placed only on the outer surface 2 and the steps b) and c) are carried out, and subsequently

in the further steps the membrane 4 is placed further on all sides of the outer side surfaces 7, 8 facing the outer surface and the steps b) and c) are carried out. In such a method the use of a hot-melt adhesive composition is especially advantageous since it can be repeatedly melted and cooled off again and nevertheless the adhesive bond between the membrane and the tubbing is ensured. For example, when during the supplying of heat during the connecting of the outer surface, areas of the hot-melt adhesive layer are melted and come to rest in the further step on one of the sides of the outer side surfaces 7, 8 facing the outer surface and become bonded to it.

Furthermore, it can be advantageous, among other things, if the membrane 4 that is placed on the outer surface 2 and the membrane 4 that is placed on all sides of the outer side surfaces 7, 8 facing the outer surface are two separate membranes. However, they must be bonded with one another in such a manner, in particular welded or adhered, that water-tightness is ensured.

Furthermore, it can be especially advantageous if the membrane 4 which is placed on the outer surface 2 and the membrane 4 that is placed on all sides of the outer side surfaces 7, 8 facing the outer surface are one and the same membrane.

Furthermore, it can be advantageous if the membrane is pressed on the tubbing, in particular with a drum or a roller, before and/or during the cooling of the hot-melt adhesive layer in step c), in particular between steps b) and c).

FIGS. 3 and 4 show steps a) and b) of the method.

FIG. 3 shows a first embodiment. In it the membrane 4 is placed on the outer surface 2 of the tubbing in step a), wherein the hot-melt adhesive layer 5 faces the tubbing 1.

Especially when the hot-melt adhesive layer is a tack-free hot-melt adhesive layer it can be moved on the outer surface, which makes possible, for example, final positioning of the membrane.

Furthermore, FIG. 3 shows a variant of step b). Here the supply of heat takes place in step b) during the placing of the hot-melt adhesive layer in step a) into the gap 13 formed between the hot-melt adhesive layer and the outer surface or outer side surfaces of the tubbing during the placing. As a result of the heat, partial melting of the hot-melt adhesive composition starts. As a result, the hot-melt adhesive composition becomes soft and readily adhesive and can bond with the tubbing. In the next step c) the hot-melt adhesive composition is cooled again, as a result of which an adhesive bond takes place between the membrane and the tubbing.

FIG. 4 shows another embodiment. In it the heat is supplied by a heat source 14 in step b) on the side of the membrane 4 opposite the hot-melt adhesive layer 5 and is transferred over the thermoplastic sealing layer 6 to the hot-melt adhesive layer 5. As a result of the heat, partial melting of the hot-melt adhesive layer 5 begins. As a consequence, the hot-melt adhesive composition becomes at least partially flowable and can contact the tubbing. In the next step c) the hot-melt adhesive composition is cooled again, as a consequence of which an adhesive bond takes place between the membrane and the tubbing.

The tubbing is preferably suited for use in tunnel structures with a diameter of 0.5-50 m.

Another aspect of the invention relates to a structure, in particular to a tunnel, containing a tubbing in accordance with the invention.

### EXAMPLES

The invention is also illustrated in the following using examples.

A tunnel membrane Sikaplan® WT2200 22HL2 obtainable from Sika Sarnafil AG, Switzerland was coated with a non-reactive hot-melt adhesive SikaMelt®0-9171 obtainable from Sika Automotive GmbH, Germany. Amounts of 200, 400 and 600 g/m² were selected as application weights of SikaMelt®-9171. SikaMelt®-9171 has a softening point measured according to the ring and ball method according to DIN EN 1238 of 160° C. and a crossover temperature of 109° C. determined by DTMA according to the method that was previously described. Subsequently, the coated membranes were applied by heat activation (flame) to a tubbing. After having cooled for 1-2 minutes very good strength was able to be manually observed. The adhesive pull values determined for all three application weights were always >1.5N/mm^{2.} The use of a vacuum gripper is made possible with this strength.

The coated tunnel membrane Sikaplan®WT2200 22HL2 with 600 g/m² Sikamelt®-9171 was produced in a width of 30 cm. It was applied with heat activation in the edge area of a tubbing, wherein 25 cm of the membrane were applied on the concave outside of the tubbing. This took place with activation by heat (flame) followed by pressing with a roller. In a second step the protruding membrane was heated on the bottom, coated side and deep-drawn by hand. After 30 seconds the required final strength was achieved. It was shown with this test that the membrane in the edge area can be deep-drawn and permanently fixed.

### LIST OF REFERENCE NUMERALS

Tubbing
Convexly curved outer surface
Concavely curved inner surface
Membrane
Hot-melt adhesive layer
Thermoplastic sealing layer
Longitudinal side surface
Front side surface
Sealing groove surrounding the outer side surfaces like a frame
Sealing body
Sealing coating
Gap
Heat source

1. A method for the production of a tubbing of concrete for jacketing a tunnel, in particular a traffic tunnel, wherein the tubbing has a convexly curved outer surface and a concavely curved inner surface opposite the outer surface, comprising the following steps:
a) placing a membrane comprising a hot-melt adhesive layer and a thermoplastic sealing layer on the outer surface and, furthermore, at least partially on at least one, in particular all of the sides of the outer side surfaces of the tubbing, which sides face the outer surface, wherein the hot-melt adhesive layer faces the tubbing;
b) supplying heat with partial melting of the hot-melt adhesive layer; and
c) cooling the hot-melt adhesive layer with formation of an adhesive composite between membrane and the tubbing.

2. The method according to claim 1, wherein the tubbing comprises a sealing groove surrounding the outer side surfaces, in which a sealing body is arranged.

3. The method according to claim 1, wherein the sealing layer is placed partially, in particular up to the sealing groove, on all sides of the outer side surfaces of the tubbing that face the outer surface.

4. The method according to claim 1, wherein the thermoplastic sealing layer contains thermoplastic polyolefins and/or polyvinyl chloride.

5. The method according to claim 1, wherein the thermoplastic sealing layer comprises material selected from the group consisting of high-density polyethylene, medium-density polyethylene, low-density polyethylene, polyethylene, polypropylene, polyethylene terephthalate, polystyrene, polyvinyl chloride, polyamides, ethylene-vinyl acetate, chlorosulfonated polyethylene and thermoplastic polyolefins.

6. The method according to claim 1, wherein the tubbing comprises a sealing coating between the outer surface and the hot-melt adhesive layer, wherein the sealing layer is selected from the group consisting of methacrylic resin, polyester resin, epoxy resin, polyurethane and polyurea.

7. The method according to claim 1, wherein the sealing coating is furthermore arranged at least partially on all outer side surfaces.

8. The method according to claim 1, wherein the hot-melt adhesive layer consists of a non-reactive hot-melt adhesive composition.

9. The method according to claim 1, wherein the hot-melt adhesive layer consists of a hot-melt adhesive composition that comprises a thermoplastic poly-α-olefin that is solid at 25° C., preferably an atactic poly-α-olefin, in particular in an amount of more than 50 wt %, preferably more than 60 wt % relative to the amount of the hot-melt adhesive composition.

10. The method according to claim 1, wherein the hot-melt adhesive layer consists of a hot-melt adhesive composition which has a melting point of 80 to 200° C., in particular from 130 to 180° C.

11. The method according to claim 1, wherein the hot-melt adhesive layer has an application weight of 50 to 1000 g/m², in particular 200 to 800 g/m².

12. The method according to claim 1, wherein in step b) the supplying of heat takes place during the placing of the membrane in step a), in particular into the gap formed during the placing between the hot-melt adhesive layer and the tubbing.

13. The method according to claim 1, wherein in step b) the supplying of heat takes place on the side of the membrane opposite the hot-melt adhesive layer and is transferred via the thermoplastic sealing layer onto the hot-melt adhesive layer.

14. The method according to claim 1, wherein in step b) the supplying of heat takes place in such a manner that the temperature of the hot-melt adhesive layer does not exceed a temperature that is at least 30° C., preferably at least 40° C. below the melting point of the hot-melt adhesive layer.

15. A structure, in particular a tunnel, containing a tubbing obtained from a method according to claim 1.

16. The method according to claim 2, wherein the sealing layer is placed partially, in particular up to the sealing groove, on all sides of the outer side surfaces of the tubbing that face the outer surface.

17. The method according to claim 2, wherein the thermoplastic sealing layer contains thermoplastic polyolefins and/or polyvinyl chloride

18. The method according to claim 4, wherein the thermoplastic sealing layer comprises material selected from the group consisting of high-density polyethylene, medium-density polyethylene, low-density polyethylene, polyethylene, polypropylene, polyethylene terephthalate, polystyrene, polyvinyl chloride, polyamides, ethylene-vinyl acetate, chlorosulfonated polyethylene and thermoplastic polyolefins.

19. The method according to claim 5, wherein the tubbing comprises a sealing coating between the outer surface and the hot-melt adhesive layer, wherein the sealing layer is selected from the group consisting of methacrylic resin, polyester resin, epoxy resin, polyurethane and polyurea.

20. The method according to claim 6, wherein the sealing coating is furthermore arranged at least partially on all outer side surfaces.
